(19) United States
(12) Patent Application Publication
(10) Pub. No.: US 2005/0162857 A1
(43) Pub. Date: Jul. 28, 2005

(54) Lamp unit for vehicle and illumination lamp for vehicle

(75) Inventor: Michio Tsukamoto, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD.

(21) Appl. No.: 11/019,316

(22) Filed: Dec. 23, 2004

(30) Foreign Application Priority Data
Dec. 24, 2003 (JP) P.2003-426715

(51) Int. Cl. G01D 11/28

(52) U.S. Cl. 362/509

(57) ABSTRACT

The lamp unit for a vehicle is configured such that light incident into a translucent member from a light emitting element is sequentially reflected by the inner surfaces of first and second reflecting surfaces, and then irradiated from an irradiating surface in the lamp unit forward direction. The first reflecting surface is configured by the curved surface of a substantially parabolic cylindrical shape, thereby reflecting by the inner surface thereof light from the light emitting element outward in the radial direction of an optical axis Ax2 such that light from the light emitting element is spread along the plane including the optical axis Ax, but not orthogonal to the plane. Thus, even when the translucent member is formed in a plane plate shape, the light irradiated from the light emitting element and reflected by the inner surface of the first reflecting surface is incident into the second reflecting surface.

This application claims foreign priority based on Japanese patent application JP 2003-426715, filed on Dec. 24, 2003, the contents of which is incorporated herein by reference in its entirety.

### BACKGROUND OF THE INVENTION

1. Field of the Invention

The present invention relates to a lamp unit for a vehicle and an illumination lamp for a vehicle using a light emitting element such as a light emitting diode as a light source.

2. Description of the Related Art

In the related art, a lamp unit for a vehicle uses a light emitting diode as a light source. For example, JP-A-2002-50214 describes a related art lamp unit for a vehicle having a light emitting diode directed in the forward direction of the lamp unit and a light transmission (translucent) member that covers the light emitting diode from the front side thereof.

This related art lamp unit for a vehicle is configured such that light from the light emitting diode being incident at the rear end portion of the translucent member thereof is introduced to the front end surface of the translucent member and then emitted from the front end portion thereby to irradiate the forward area of the lamp unit through a projection lens. When the related art lamp unit described in the above-mentioned JP-A-2002-50214 is used, the utilization factor of light from the light emitting diode can be improved.

However, the related art has various problems and disadvantages. For example, but not by way of limitation, since the projection lens is disposed at the forward portion of the translucent member, there arises a problem that the outer configuration of the lamp unit seen from the front direction thereof becomes a shape close to a circle or a square and thus cannot be set to a shape with a thin-width.

### SUMMARY OF THE INVENTION

An object of the invention is to provide a lamp unit for a vehicle, using a light emitting element as a light source, which can enhance the utilization factor of light from the light emitting element and set the outer configuration of the lamp unit seen from the front direction thereof to a shape with a thin-width.

While the foregoing objects are provided for the present invention, it is not necessary for these objects to be achieved in order for the invention to operate properly. Further, other object, or no objects at all, may be achieved by the present invention without affecting its operation.

The invention attains the aforesaid object in a manner that a translucent member is disposed so as to cover a light emitting element from the front side thereof and some idea is applied to the surface configuration of the translucent member.

That is, a lamp unit for a vehicle according to the invention is arranged in a manner that in the lamp unit for a vehicle comprising a light emitting element disposed toward a forward direction on an optical axis extending in a front-to-rear direction of the lamp unit, and a translucent member disposed to cover the light emitting element from a forward side thereof, the lamp unit for a vehicle is characterized in that
a part of a front surface of the translucent member is configured as a first reflecting surface which reflects on an inner surface thereof the light, which is incident into the translucent member from the light emitting element, outward in a radial direction of the optical axis in a manner that the light from the light emitting element is spread as to a direction along a plane including the optical axis but not spread as to a direction orthogonal to the plan,
a part of a rear surface of the translucent member is configured as a second reflecting surface which reflects on an inner surface thereof the light, irradiated from the light emitting element and then reflected by the inner surface of the first reflecting surface, in the forward direction, and
another part of the front surface of the translucent member is configured as an irradiating surface which emits the light, irradiated from the light emitting element and then reflected by the inner surface of the second reflecting surface, in the forward direction of the lamp unit from the translucent member.

The “light emitting element” means a light source with an element configuration having a light emitting portion for emitting light of a substantially point shape, and the kind of the light emitting element is not limited to a particular one, and so a light emitting diode, a laser diode may be employed as the light emitting element, for example.

The “translucent member” is not limited in its material to particular one so long as it is a member with translucency, and so a member formed by transparent composite resin, a member formed by glass etc. may be employed as the translucent member, for example.

The surface shape of the “first reflecting surface” is not limited to a particular one so long as the first reflecting surface is configured so as to reflect, on the inner surface thereof, the light incident into the translucent member from the light emitting element in a manner that the light from the light emitting element is spread as to the direction along the plane including the optical axis but not spread as to the direction orthogonal to the plan.

The surface shape of the “second reflecting surface” is not limited to a particular one so long as the second reflecting surface is configured so as to reflect the light, irradiated from the light emitting element and then reflected by the inner surface of the first reflecting surface, in the forward direction.

The “irradiating surface” may be a surface which is formed so as to pass the light, irradiated from the light emitting element and then reflected by the inner surface of the second reflecting surface, as it is in the forward direction of the lamp unit or to refract or spread the light.

As shown in the above-disclosed configuration, since the lamp unit for a vehicle according to the invention is arranged in a manner that the translucent member is disposed so as to cover the light emitting element, which is disposed toward the forward direction on the optical axis extending in the front-to-rear direction of the lamp unit, from the forward side thereof, the utilization factor of the light emitted from the light emitting element can be enhanced.

In this case, a part of the front surface of the translucent member is configured as the first reflecting surface which reflects on the inner surface thereof the light, which is incident into the translucent member from the light emitting element, outward in a radial direction of the optical axis, and a part of the rear surface of the translucent member is configured as the second reflecting surface which reflects on the inner surface thereof the light, irradiated from the light emitting element and then reflected by the inner surface of the first reflecting surface, in the forward direction. Further, since the first reflecting surface is configured in a manner that the light from the light emitting element is spread as to the direction along a plane including the optical axis but not spread as to the direction orthogonal to the plan, even when the translucent member is formed in a plane plate shape, the light irradiated from the light emitting element and reflected by the inner surface of the first reflecting surface can be surely incident into the second reflecting surface.

Further, another part of the front surface of the translucent member is configured as the irradiating surface which emits the light, irradiated from the light emitting element and then reflected by the inner surface of the second reflecting surface, in the forward direction of the lamp unit from the translucent member. Thus, when each of the second reflecting surface and the irradiating surface is set to have a suitable surface configuration, the light irradiation in the forward direction of the lamp unit can be controlled even if a projection lens is not disposed at the forward position of the translucent member like the related-art technique. As a result, the outer configuration of the lamp unit seen from the front direction thereof can be set to a shape with a thin-width.

In this manner, according to the invention, in the lamp unit for a vehicle using a light emitting element as a light source, the utilization factor of light from the light emitting element can be enhanced and the outer configuration of the lamp unit seen from the front direction thereof can be set to a shape with a substantially thin-width.

According to the aforesaid configuration, although the configuration of “the light emitting element” is not limited to a particular one as described above, when the light emitting element is configured to include a light emitting chip and a sealing resin for sealing the light emitting chip and further to integrally form the sealing resin with the translucent member, the configuration of the lamp unit can be simplified. In this case, as a mode at the time of “integrally forming” the sealing resin with the translucent member, there may be employed a mode in which the sealing member is sealed by the translucent member or a mode in which the light emitting chip is directly sealed by the translucent member thereby to make the translucent member also have a function of sealing resin, for example.

Further, although the surface shape of the “second reflecting surface” is not limited to a particular one as described above, when the second reflecting surface is configured by a curved surface of a substantially cylindrical surface shape which reflects on the inner surface thereof the light, irradiated from the light emitting element and then reflected by the inner surface of the first reflecting surface, in the forward direction as substantially parallel rays, since the substantially parallel rays are incident into the irradiating surface, the irradiation light can be controlled accurately. Thus, when the irradiation surface is set to have a suitable shape, a desired light distribution pattern can be formed easily. Further, when the second reflecting surface is configured so as to reflect on the inner surface thereof the light reflected by the inner surface of the first reflecting surface in the forward direction as substantially parallel rays, the irradiation light can be controlled accurately even when the irradiating surface is formed at an arbitrary position in the front-to-rear direction of the lamp unit.

In the aforesaid configuration, although each of the first reflecting surface, the second reflecting surface and the irradiating surface may be formed at one portion, when the first reflecting surface, the second reflecting surface and the irradiating surface are formed at each of both sides with respect to the optical axis, the utilization factor of light from the light emitting element can be further enhanced.

Further, as an illumination lamp for a vehicle such as a head lamp, when a plurality of the lamp units for a vehicle according to the invention are provided in the direction orthogonal to the plane (that is, the thickness direction of the translucent member), the illumination lamp for a vehicle can be designed as a novel one not present in the related-art technique.

Additionally, an illumination lamp for a vehicle that includes a plurality of lamp units within a lamp chamber of a lamp body. The lamp units include a first type of the lamp units that is of a projection type, and a second type of the lamp units. The second type of lamp units have a light emitting element, a translucent member and a supporting plate, wherein the translucent member includes a first reflecting surface that reflects light from the light emitting element and to a second reflecting surface, and an irradiating surface that receives light reflected by the second surface and emits light in a forward direction of the lamp unit.

### BRIEF DESCRIPTION OF THE DRAWINGS

FIG. 1 is a front view showing an illumination lamp for a vehicle according to an exemplary, non-limiting embodiment of the invention.

FIG. 2 is a sectional diagram cut along a line II-II in FIG. 1.

FIG. 3 is a side sectional diagram showing the lamp unit for forming a basic light distribution pattern in the illumination lamp for a vehicle.

FIG. 4 is a perspective view of the lamp unit for forming a small-area light distribution pattern in the illumination lamp for a vehicle.

FIG. 5 is a sectional side view showing in detail a part of the lamp unit for forming the small-area light distribution pattern.

FIG. 6 is a sectional view cut along a line VI-VI in FIG. 5.

FIG. 7 is a sectional view cut along a line VII-VII in FIG. 5, wherein (a) shows the lamp unit for forming the small-area light distribution pattern, (b) shows the lamp unit for forming the middle-area light distribution pattern and (c) shows the lamp unit for forming the large-area light distribution pattern.

FIG. 8 illustrates the low-beam light distribution pattern formed from the illumination lamp for a vehicle.

FIGS. 9(a)-(d) are diagrams showing four kinds of light distribution patterns constituting the low-beam light distribution pattern.

FIG. 10 illustrates a lamp unit according to the first modified example of the exemplary, non-limiting embodiment.

FIG. 11 illustrates a lamp unit according to the second modified example of the exemplary, non-limiting embodiment.

FIG. 12 illustrates a lamp unit according to the third modified example of the exemplary, non-limiting embodiment and is similar to FIG. 5.

FIG. 13 illustrates a lamp unit according to the fourth modified example of the exemplary, non-limiting embodiment and is similar to FIG. 5.

### DETAILED DESCRIPTION OF THE INVENTION

Hereinafter, an exemplary, non-limiting embodiment of the invention will be explained with reference to the accompanying drawings. In the present invention, terms are presumed to have their ordinary meaning as would be understood by one of ordinary skill in the relevant art. However, terms may also be operationally defined in this disclosure to have a specific meaning.

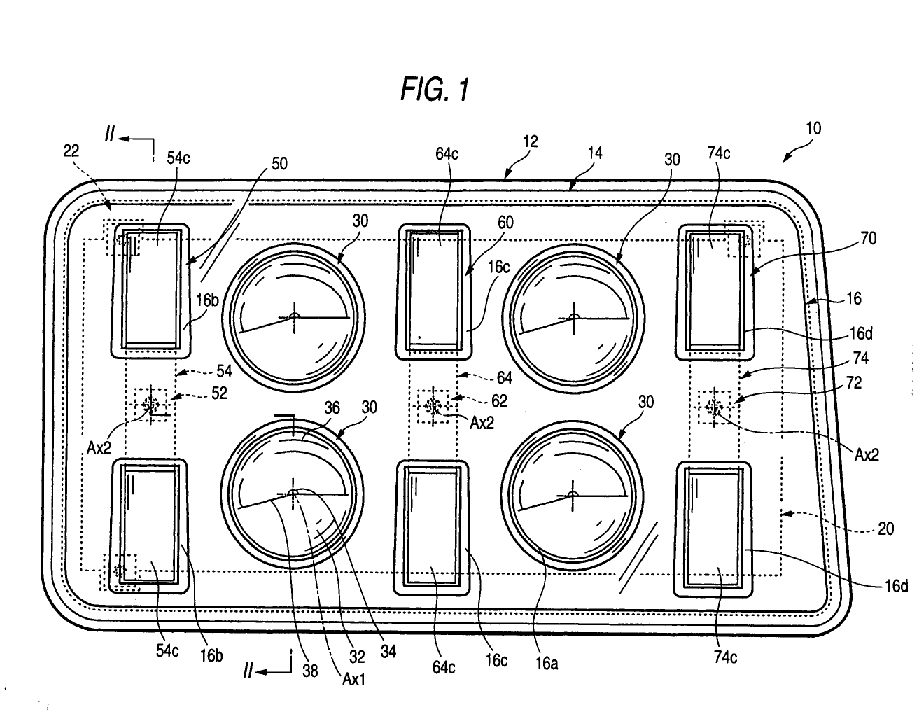

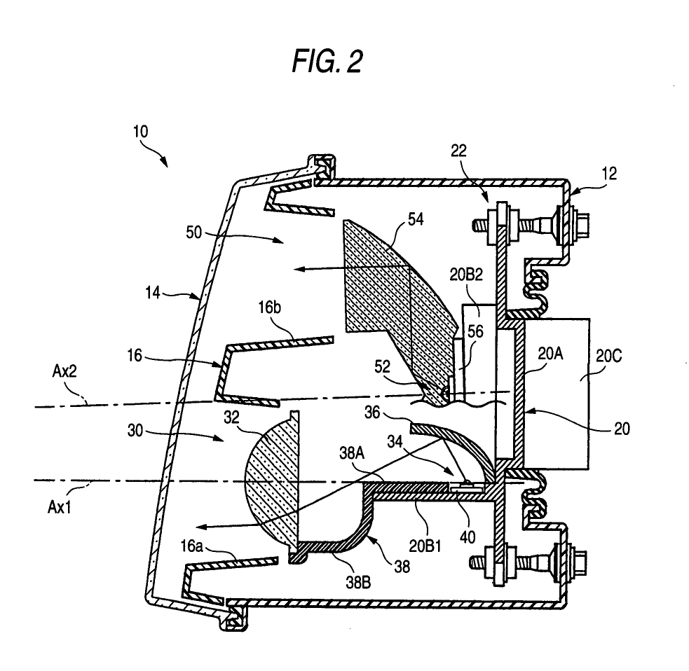

FIG. 1 is a front view showing an illumination lamp for a vehicle according to the exemplary, non-limiting embodiment of the present invention, and FIG. 2 is a sectional diagram cut along a line II-II in FIG. 1. An illumination lamp 10 for a vehicle is a head lamp provided at the right side of the front end portion of a vehicle, and is configured in a manner that seven lamp units 30, 50, 60, 70 are housed within a lamp chamber formed by a lamp body 12 and a translucent cover 14 attached to the opening portion at the front end of the lamp body. The four lamp units 30 are each set in its outer configuration as seen from the front direction thereof to a substantially circular shape, and are disposed at upper and lower stages. The remaining three lamp units 50, 60, 70 are each set in its outer configuration seen from the front direction thereof to a substantially longitudinal rectangular shape with a thin-width and are disposed with an interval in the vehicle width direction so as to sandwich two of the four lamp units 30 between adjacent two of the remaining three lamp units.

An inner panel 16 is provided along the translucent cover 14 within the lamp chamber. Cylindrical opening portions 16a, 16b, 16c and 16d surround the lamp units 30, 40, 50, 60 and 70 at the positions corresponding to these lamp units of the inner panel 16, respectively. In this case, the cylindrical opening portions 16b, 16c and 16d corresponding to the three lamp units 50, 60 and 70 are separated in upper and lower stages.

The seven lamp units 30, 40, 50, 60 and 70 are supported so as to be able to incline in the vertical and horizontal directions by the lamp body 12 through an aiming mechanism 22 in a state of being attached to a common unit supporting member 20. The unit supporting member 20 is configured by die-cast parts and is provided with a vertical panel portion 20A, a unit attachment portion 20B1 extending forward at plural portions of the vertical panel portion 20A, and a heat sink portion 20C formed by a plurality of radiation fins extending backward from the vertical panel portion 20A to a position exposed to the external space of the lamp.

In the illumination lamp 10 for a vehicle, a low-beam light distribution pattern is formed by lights irradiated from the seven lamp units 30, 50, 60 and 70.

Among the seven lamp units 30, 50, 60 and 70, the four lamp units 30 are lamp units for radiating lights to form the basic light distribution pattern of the low-beam light distribution pattern. The remaining three lamp units 50, 60 and 70 are lamp units for radiating lights to reinforce the basic light distribution pattern. In this case, among the three lamp units 50, 60 and 70, the lamp unit 50 on the outermost side in the vehicle width direction is a lamp unit for forming a light distribution pattern for small area distribution, the lamp unit 60 at the center position is a lamp unit for forming a light distribution pattern for middle area distribution, and the lamp unit 70 on the innermost side in the vehicle width direction is a lamp unit for forming a light distribution pattern for large area distribution.

The four lamp units 30 for forming the basic light distribution pattern are arranged such that optical axes Ax1 thereof extend in a direction substantially orthogonal to the vertical panel portion 20A so as to be in parallel from one another. The optical axes Ax1 of the respective lamp units 30 are set so as to extend downward by about 0.5 to 0.6 degrees with respect to the longitudinal direction of a vehicle when the optical axis adjusting process using the aiming mechanism 22 is completed. On the other hand, the optical axes Ax2 of the remaining three lamp units 50, 60 and 70 are set so as to be directed downward slightly with respect to the optical axes Ax1 of the lamp units 30.

Next, the configurations of the lamp units 30, 50, 60 and 70 will be explained. First, the configuration of the lamp units 30 for forming the basic light distribution pattern will be explained.

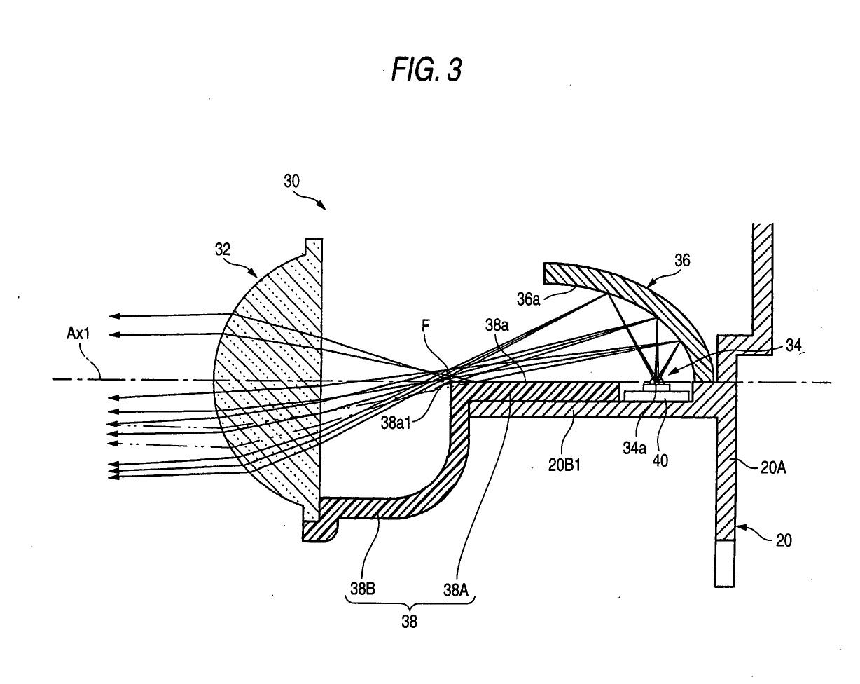

FIG. 3 is a side sectional diagram showing the lamp unit 30 in detail. The lamp unit 30 is a projector type lamp unit and is provided with a projection lens 32 disposed on the optical axis Ax1, a light emitting element 34 disposed at the rear side of the projection lens 32, a reflector 36 disposed so as to cover the light emitting element 34 from the upper side thereof, and a straight traveling preventing member 38 disposed between the light emitting element 34 and the projection lens 32.

The projection lens 32 is made of transparent resin and is configured by a plane-convex lens which front side surface is formed as a convex plane and rear side surface is formed as a plane.

The light emitting element 34 is a white light emitting diode having a light emitting chip 34a with an area of about 0.3 to 1.0 mm square. The light emitting element is fixed on the unit attachment portion 20B1 of the unit supporting member 20 through a plate 40 such that the light emitting chip 34a is disposed upward so as to be directed vertically on the optical axis Ax1.

The reflector 36 is configured to reflect the light emitted from the light emitting element 34 in the forward direction so as to close to the optical axis Ax1 thereby to substantially focus the reflected light near the backward side focusing point F of the projection lens 32. Structurally, the reflection surface 36a of the reflector 36 is set in a manner that the sectional shape including the optical axis Ax1 is formed in a substantially elliptical shape and the eccentricity becomes larger gradually from the vertical section toward the horizontal section.

The reflection surface 36a is arranged to substantially focus the light emitted from the light emitting element 34 at a position slightly forward side of the backward side focusing point F. The reflector 36 is fixed at its peripheral lower end portion to the unit attachment portion 20B1 of the unit supporting member 20.

The straight traveling preventing member 38 is configured by a main body portion 38A which upper surface 38a is formed in a substantially L-shape when seen from the front side of the lamp, and a lens holder portion 38B extended forwardly from the front end portion of the main body portion 38A.

The upper surface 38a of the main body portion 38A extends backward from the backward side focusing point F of the projection lens 32, and the left side area (the right side area when seen from the front side of the lamp) with respect to the optical axis Ax1 is formed by a plane extending horizontally to the left direction from the optical axis Ax1. The right side area with respect to the optical axis Ax1 is formed by a plane extending in an inclined right downward direction (for example, downward by about 15 degrees) from the optical axis Ax1. The front end edge 38a1 of the upper surf ace 38a is formed in a substantially arc shape along the focusing surface of the backward side focusing point F of the projection lens 32.

The upper surface 38a is subjected to the mirror surface processing such as aluminum vapor deposition, thereby constituting the upper surface 38a as a reflection surface. The main body portion 38A is arranged such that the upper surface 38a thereof prevents the straight traveling of a part of the reflection light from the reflection surface 36a of the reflector 36 and reflect the part of the reflection light upward. The upper surface 38a is fixed at its lower surface to the unit attachment portion 20B1 of the unit supporting member 20.

The lens holder portion 38B bends downward from the front end portion of the main body portion 38A and extends forward thereby to support the projection lens 32 at the front end portion of the lens holder portion.

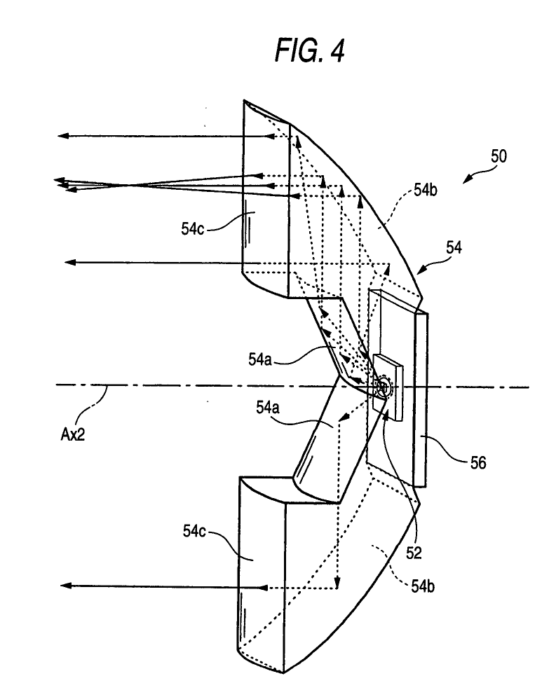

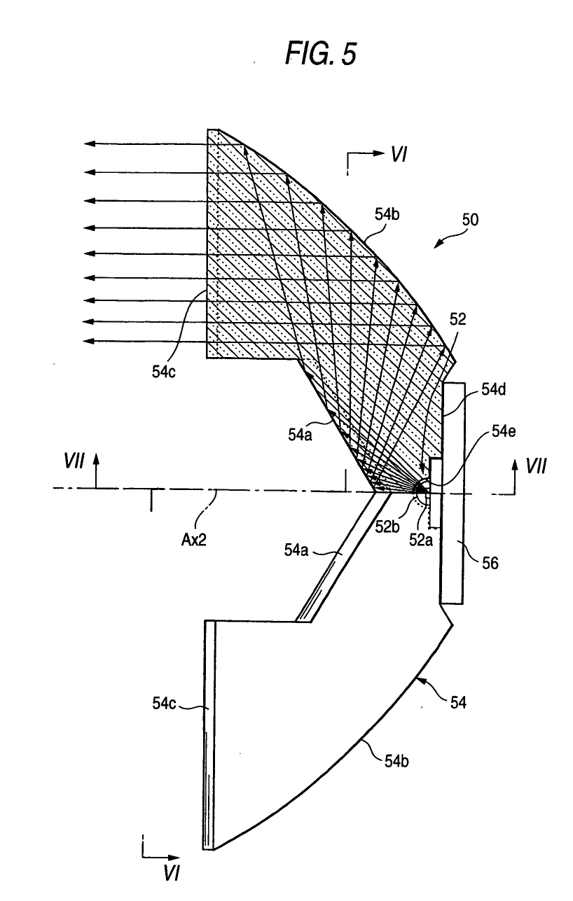

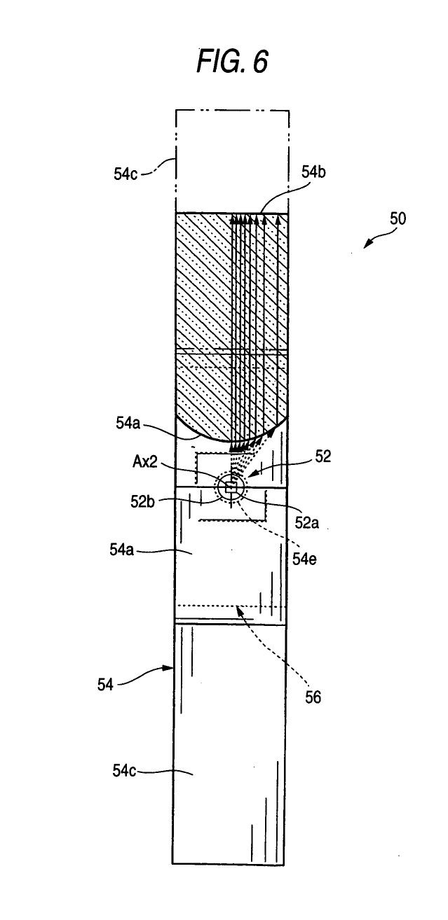

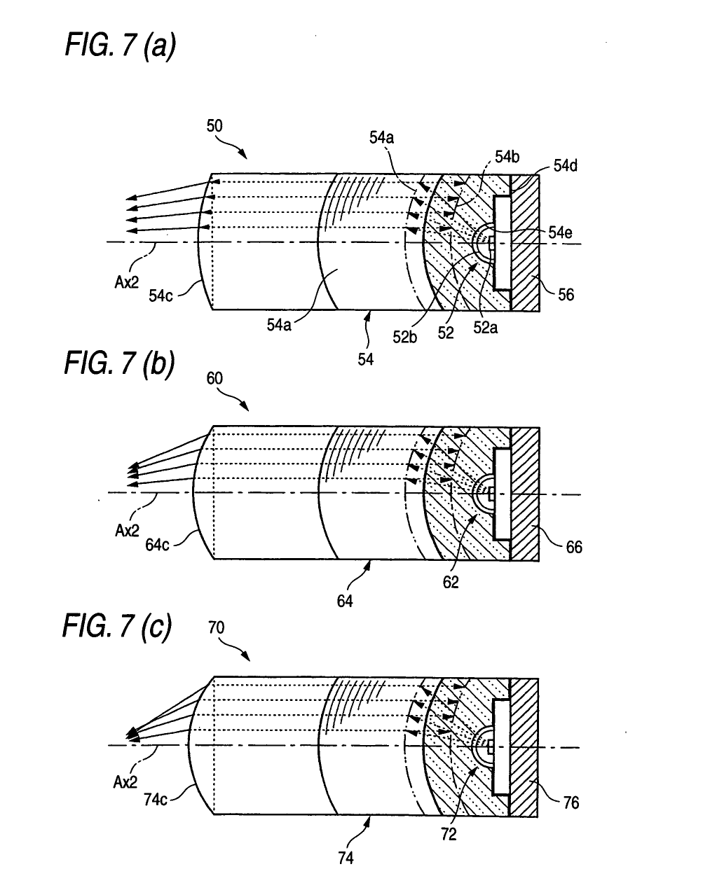

Next, the configuration of the lamp unit 50 for forming a small-area light distribution pattern will be explained. FIG. 4 is a perspective view of the lamp unit 50 shown as a single unit. FIG. 5 is a sectional side view showing a part of the lamp unit 50, FIG. 6 is a sectional view cut along a line VI-VI in FIG. 5, and FIG. 7(a) is a sectional view cut along a line VII-VII in FIG. 5.

The lamp unit 50 is configured by a light emitting element 52, a translucent member 54 and a supporting plate 56. The light emitting element 52 is a white light emitting diode having a light emitting chip 52a that is about 0.3 to 1.0 mm square and a hemispherical sealing resin 52b for sealing the light emitting chip 52a. The light emitting element is disposed so as to direct the light emitting chip 52a in the forward direction on an optical axis Ax2.

The translucent member 54 is a plate-shaped member made of transparent resin having a substantially C-shape in its side configuration and is disposed to cover the light emitting element 52 from the forward side thereof. Structurally, the translucent member 54 is set to have a transverse width of about 20 mm as a plate thickness and have a height of about 140 mm. A concave portion 54e for surrounding the light emitting chip 52a of the light emitting element 52 in a hemispherical shape is formed at the surface 54d of the translucent member 54.

Hereinafter, the configuration of the translucent member 54 will be explained. In this case, since the translucent member 54 is substantially symmetrical in the vertical direction with respect to the optical axis Ax2, the explanation will be made as to the upper half portion.

An area positioned near the upper portion of the optical axis Ax2 in the front surface of the translucent member 54 is configured as a first reflecting surface 54a which reflects light, irradiated from the light emitting element 52 and incident into the translucent member 54, upward such that the light is reflected by the inner surface of the translucent member. In order to realize such a function, mirror surface processing such as aluminum vapor deposition is performed on the front surface area of the translucent member 54 where the first reflecting surface 54a is positioned. In this case, the first reflecting surface 54a is configured by a substantially parabolic cylindrical surface having a substantially parabolic shape in its horizontal section and extending in an inclined upward direction linearly. Thus, the first reflection surface reflects the light on the inner surface thereof such that the light from the light emitting element 52 is spread in the direction along the vertical plane including the optical axis Ax, but is not spread as to the direction along the horizontal surface.

An area positioned above the first reflecting surface 54a in the rear surface of the translucent member 54 is configured as a second reflecting surface 54b which reflects light, irradiated from the light emitting element 52 and then reflected by the inner surface of the first reflecting surface 54a, in the forward direction such that the light is reflected by the inner surface of the translucent member. To realize such a function, the mirror surface processing such as aluminum vapor deposition is performed on the rear surface area of the translucent member 54 where the second reflecting surface 54b is positioned.

In this case, the second reflecting surface 54b is configured by a substantially parabolic surface having a substantially parabolic shape in its vertical section and extending linearly in the horizontal direction orthogonal to the optical axis Ax2. Thus, the second reflection surface reflects the light on the inner surface thereof in a manner that the light from the light emitting element 52 reflected by the inner surface of the first reflecting surface 54a is reflected in the forward direction as substantially parallel rays.

Further, an area positioned above the first reflecting surface 54a in the front surface of the translucent member 54 is configured as an irradiating surface 54c which emits light, irradiated from the light emitting element 52 and then reflected by the inner surface of the second reflecting surface 54b, in the forward direction of the lamp unit 50 from the translucent member 54. In this case, the irradiating surface 54c is configured by a curved surface of a cylindrical surface shape having an arc shape in its horizontal section and extending in the vertical direction linearly. Thus, the irradiation surface acts such that the substantially parallel rays arrived at the irradiating surface 54c are maintained as it is as substantially the parallel rays as to the vertical direction. As to the horizontal direction, the substantially parallel rays arriving at the irradiation surface are once converged and emitted from the irradiating surface 54c as light spread in the horizontal direction.

As described above, the translucent member 54 is symmetrical in the vertical direction with respect to the optical axis Ax2. As a result, the first and second reflecting surfaces 54a, 54b and the irradiating surface 54c are also formed at the lower half portion.

The supporting plate 56 is a member made of metal which extends in the vertical direction along the rear end surface 54d of the translucent member 54 and fixedly supports the light emitting element 52 at the center portion of the front surface thereof. The lamp unit 50 is fixedly supported by the unit attachment portion 20B2 of the unit supporting member 20 at the rear surface of the supporting plate 56.

Next, the configuration of the lamp unit 60 for forming a middle-area light distribution pattern will be explained. FIG. 7(b) is a diagram showing the lamp unit 60 in detail and is similar to FIG. 7(a). The lamp unit 60 is configured by a light emitting element 62, a translucent member 64 and a supporting plate 66.

The configurations of the light emitting element 62 and the supporting plate 66 are substantially the same as the light emitting element 52 and the supporting plate 56 of the lamp unit 50.

Although the translucent member 64 differs in its surface shape of the irradiating surface 64c from the irradiating surface 54c of the translucent member 54 of the lamp unit 50, the configurations other than the irradiating surface of the translucent member 64 are substantially the same as those of the translucent member 54.

That is, like the irradiating surface 54c of the translucent member 54, the irradiating surface 64c of the translucent member 64 is formed by a curved surface of a cylindrical surface shape having an arc shape in its horizontal section and extending in the vertical direction linearly. However, the curvature of the arc constituting the horizontal sectional shape of the irradiating surface 64c is larger than that of the irradiating surface 54c of the translucent member 54. Thus, the irradiation surface acts such that the substantially parallel rays arrived at the irradiating surface 64c are maintained as it is as substantially the parallel rays as to the vertical direction. On the other hand, in the horizontal direction, the substantially parallel rays arrived at the irradiation surface are emitted from the irradiating surface 64c as light is spread to a larger extent than the emitted light from the irradiating surface 54c of the translucent member 54.

Next, the configuration of the lamp unit 70 for forming a large-area light distribution pattern will be explained. FIG. 7(c) is a diagram showing the lamp unit 70 in detail and is similar to FIG. 7(a). The lamp unit 70 is configured by a light emitting element 72, a translucent member 74 and a supporting plate 76.

The configurations of the light emitting element 72 and the supporting plate 76 are same as the light emitting element 52 and the supporting plate 56 of the lamp unit 50.

Although the translucent member 74 differs in its surface shape of the irradiating surface 74c from the irradiating surface 54c of the translucent member 54 of the lamp unit 50, the configurations other than the irradiating surface of the translucent member 74 are substantially the same as those of the translucent member 54.

That is, like the irradiating surface 54c of the translucent member 54, the irradiating surface 74c of the translucent member 74 is formed by a curved surface of a cylindrical surface shape having an arc shape in its horizontal section and extending in the vertical direction linearly. However, the curvature of the arc constituting the horizontal section of the irradiating surface 74c is larger than that of the irradiating surface 64c of the translucent member 64. Thus, the irradiation surface acts in a manner that the substantially parallel rays arrived at the irradiating surface 74c are maintained as it is as substantially the parallel rays as to the vertical direction. As to the horizontal direction, the substantially parallel rays arrived at the irradiation surface are emitted from the irradiating surface 74c as light being spread to a larger extent than the emitted light from the irradiating surface 64c of the translucent member 64.

As shown in FIG. 1, each of the respective pairs of the upper and lower irradiating surfaces 54c, 64c, 74c of the translucent members 54, 64, 74 of the three lamp units 50, 60, 70 is formed as a longitudinal rectangular shape when seen from the front side thereof, and also the cylindrical opening portions 16b, 16c, 16d corresponding thereto are each formed in a longitudinal rectangular shape so as to surround the irradiating surfaces 54c, 64c, 74c, respectively.

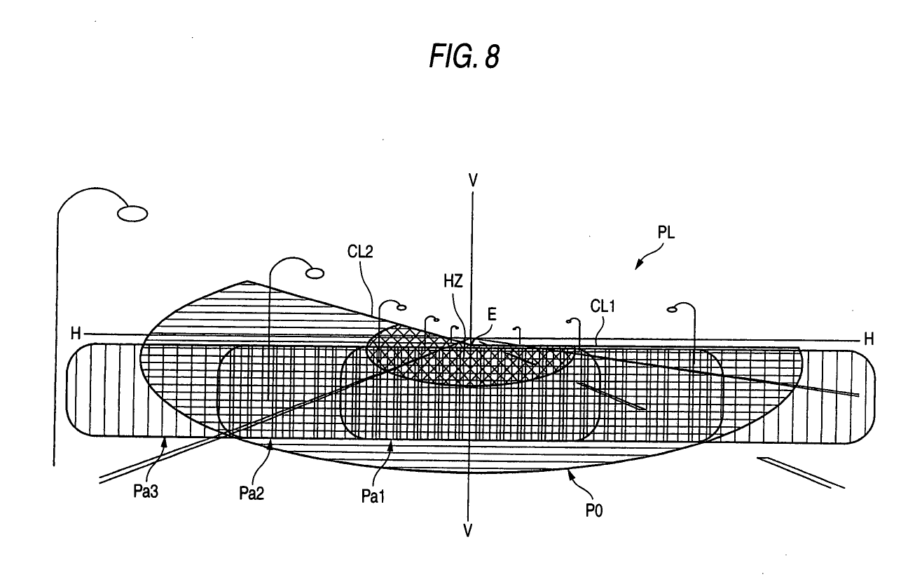

FIG. 8 perspectively shows the low-beam light distribution pattern formed on a phantom vertical screen disposed at a position about 25 m ahead of the lamp by light irradiated in the forward direction from the illumination lamp 10 for a vehicle according to the exemplary, non-limiting embodiment of the present invention.

The low-beam light distribution pattern PL is the light distribution pattern of the left distribution light and includes at its upper end edge a horizontal cut-off line CL1 and a slanted cut-off line CL2 which rises with an angle (for example, about 15 degrees) from the horizontal cut-off line CL1. An elbow point E which is a cross point between the both cut-off lines CL1 and CL2 is set at a position below by about 0.5 to 0.6 degree from a vanishing point H-V in the straight ahead of the lamp. In the low-beam light distribution pattern FL, a hot zone HZ as a high luminance area is formed so as to surround the elbow point E.

This low-beam light distribution pattern PL is formed as a composite light distribution pattern of four basic light distribution patterns P0 formed in a superimposed manner at the same position by the lights irradiated from the four lamp units 30, a small-area light distribution pattern Pa1 formed by the light irradiated from the lamp unit 50, a middle-area light distribution pattern Pa2 formed by the light irradiated from the lamp unit 60 and a large-area light distribution pattern Pa3 formed by the light irradiated from the lamp unit 70.

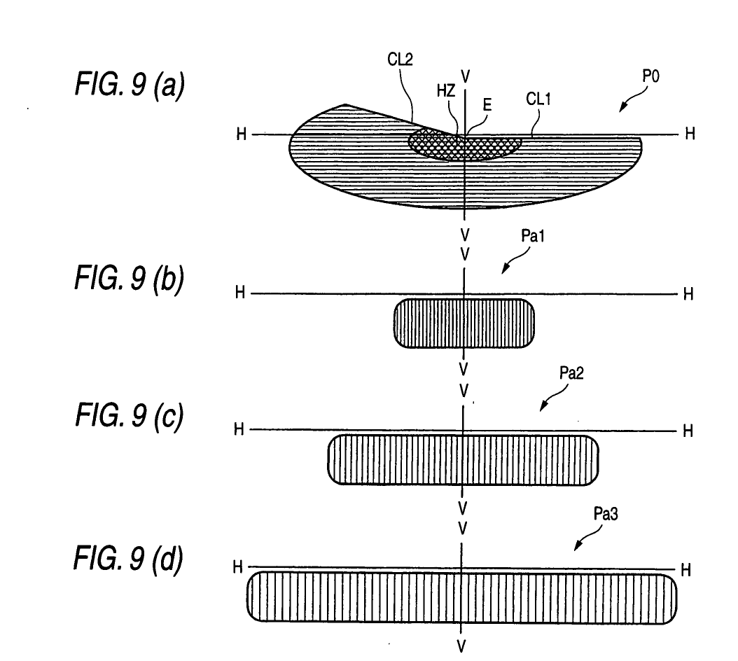

As shown in FIG. 9(a), in the basic light distribution pattern P0 formed by the lights irradiated from the lamp units 30, the horizontal and slanted cut-off lines CL1, CL2 are formed as inverted projection images of the front end edge 38a1 of the upper surface 38a of the main body portion 38A in the straight traveling preventing member 38. In this case, since the upper surface 38a of the main body portion 38A is formed as a reflection surface, as shown by two-dot chain lines in FIG. 3, the lights to be emitted upward from the projection lens 32 among the reflection lights from the reflection surface 36a of the reflector 36 are also used as the lights emitted downward from the projection lens 32 as shown by steady lines due to the reflecting action of the upper surface 38a. Thus, the utilization factor of light emitted from the light emitting element 34 can be enhanced and the hot zone HZ is formed.

As shown in FIG. 9(b), the small-area light distribution pattern Pa1 formed by the light irradiated from the lamp unit 50 is configured as a wide light distribution pattern which spreads to a small extent in the horizontal direction since of the irradiating surface 54c of the translucent member 54 has a relatively small curvature in the horizontal direction. Further, as shown in FIG. 9(c), the middle-area light distribution pattern Pa2 formed by the light irradiated from the lamp unit 60 is configured as a wide light distribution pattern which spreads in the horizontal direction since the irradiating surface 64c of the translucent member 64 has a middle curvature in the horizontal direction. Furthermore, as shown in FIG. 9(d), the large-area light distribution pattern Pa3 formed by the light irradiated from the lamp unit 70 is configured as a wide light distribution pattern which spreads to a large extent in the horizontal direction since the irradiating surface 74c of the translucent member 74 has a relatively large curvature in the horizontal direction.

The upper end edge of each of the small-area light distribution pattern Pa1, the middle-area light distribution pattern Pa2 and the large-area light distribution pattern Pa3 is positioned slightly below the horizontal cut-off line CL1. This is because the optical axis Ax2 of each of the lamp units 50, 60, 70 is set to be directed slightly downward with respect to the optical axis Ax1 of the lamp unit 30.

Although the illumination lamp 10 for a vehicle according to the embodiment includes the four kinds of lamp units 30, 50, 60, 70, the lamp units 50, 60, 70 among these lamp units are arranged such that the translucent members 54, 64, 74 are disposed so as to cover from the front sides the light emitting elements 52, 62, 72 disposed on the optical axes Ax2 toward the forward direction, respectively. Thus, the utilization factor of lights from the light emitting elements 52, 62, 72 can be enhanced.

In this case, the translucent members 54, 64, 74 are configured such that the parts of the front surfaces thereof are formed as the first reflecting surfaces 54a, 64a, 74a which reflect lights incident into the translucent members 54, 64, 74 outward in the radial direction of the optical axes Ax2 such that the lights are reflected by the inner surfaces of the translucent members, respectively, and that the rear surfaces thereof are formed as the second reflecting surfaces 54b, 64b, 74b which reflect lights, irradiated from the light emitting elements 52, 62, 72 and then reflected by the inner surfaces of the first reflecting surfaces 54a, 64a, 74a, in the forward direction in a manner that the lights are reflected by the inner surfaces of the translucent members, respectively.

However, each of the first reflecting surfaces 54a, 64a, 74a is formed in a substantially parabolic cylindrical surface shape, whereby the lights are reflected by the inner surfaces of the translucent members in a manner that the lights from the light emitting elements 52, 62, 72 are spread along the plane including the optical axes Ax2 but not spread as to the direction orthogonal to the plane. Thus, each of the translucent members 54, 64, 74 being formed in a plate shape, the lights irradiated from the light emitting elements and then reflected by the inner surfaces of the first reflecting surfaces 54a, 64a, 74a can be surely incident into the second reflecting surfaces 54b, 64b, 74b, respectively.

Further, the other parts of the front surfaces of the translucent members 54, 64, 74 are formed as the irradiating surfaces 54c, 64c, 74c which emit lights, irradiated from the light emitting elements 52, 62, 72 and then reflected by the inner surface of the second reflecting surfaces 54b, 64b, 74b, in the forward direction of the lamp units from the translucent members 54, 64, 74, respectively.

Thus, when the second reflecting surfaces 54b, 64b, 74b and the irradiating surfaces 54c, 64c, 74c are set to have suitable surface configurations, the light irradiation in the forward direction of the lamp unit can be controlled even if a projection lens is not disposed at the forward position of the translucent member like the related-art technique. As a result, the outer configuration of each of the lamp units 50, 60, 70 seen from the front direction thereof can be set to a shape with a thin-width.

In this manner, according to the embodiment, the utilization factor of lights from the light emitting elements 52, 62, 72 can be enhanced and further the outer configuration of each of the lamp units 50, 60, 70 seen from the front direction thereof can be set to a shape with a thin-width.

In particular, according to the embodiment, the second reflecting surfaces 54b, 64b, 74b of the translucent members 54, 64, 74 are configured by the curved surfaces of the substantially parabolic cylindrical shapes which reflect the lights, irradiated from the light emitting elements 52, 62, 72 and then reflected by the inner surfaces of the first reflecting surfaces 54a, 64a, 74a, in the forward direction as the substantially parallel rays on the inner surface thereof, respectively. Thus, since the substantially parallel rays are incident into the irradiating surfaces 54c, 64c, 74c,

Further, according to the embodiment, each of the irradiating surfaces 54c, 64c, 74c is formed by the curved surface of a cylindrical surface shape having the arc shape in its horizontal section and extending in the vertical direction linearly, and the curvatures of the arcs are set to be different from one another among the irradiating surfaces 54c, 64c, 74c, so that three kinds of wide light distribution patterns which differ in spread angles in the horizontal direction from one another. Thus, the brightness of the low-beam light distribution pattern PL can be increased while effectively suppressing the generation of the unevenness of the light distribution.

Further, the first and second reflecting surfaces 54a, 64a, 74a, 54b, 64b, 74b and the irradiating surfaces 54c, 64c, 74c are formed at each of the upper and lower sides with respect to the optical axis Ax, so that the utilization factor of lights from the light emitting elements 52, 62, 72 can be further enhanced.

Furthermore, as the illumination lamp 10 for a vehicle, since the lamp units 50, 60, 70 are disposed in a longitudinal posture with the interval in the vehicle width direction, the illumination lamp 10 for a vehicle is novel one and not present in the related-art technique. Further, in this case, the translucent members 54, 64, 74 of the lamp units 50, 60, 70 are arranged in a manner that the irradiating surfaces 54c, 64c, 74c each having the longitudinal rectangular shape are exposed at each of the upper and lower separated positions. Further, a pair of the upper and lower lamp units 30 of projector type, the outer configuration of each of which seen from the front direction thereof being set to the circular shape, are disposed between the adjacent two of the lamp units 50, 60, 70, so that the illumination lamp 10 for a vehicle can be designed as a further novel one not present in the related-art technique.

Although the illumination lamp 10 for a vehicle according to the embodiment is configured to include the seven lamp units 30, 50, 60, 70, the total number of these respective lamp units may be set to another number.

In the illumination lamp 10 for a vehicle according to the embodiment, although the foregoing disclosure includes the basic light distribution pattern P0 of the low-beam light distribution pattern PL being formed by the lights irradiated from the four projector type lamp units 30, this basic light distribution pattern may be formed by using the lamp unit other than the lamp units 30.

Although the illumination lamp 10 for a vehicle according to the embodiment is configured in a manner that only the lamp units 30, 50, 60, 70 for forming the low-beam light distribution pattern PL are housed within the lamp chamber, the lamp units for forming a high-beam light distribution pattern may also be housed within the same lamp chamber.

The illumination lamp 10 for a vehicle according to the embodiment is explained as the head lamp provided at the right side of the front end portion of a vehicle. However, even in the case where the illumination lamp for a vehicle according to the embodiment is used as a head lamp provided at the left side of the front end portion of a vehicle or as an illumination lamp for a vehicle other than the head lamp such as an adverse weather lamp or a fog lamp, the action and technical effects similar to those of the aforesaid embodiment can be obtained, so long as the configuration similar to that of the aforesaid embodiment is employed.

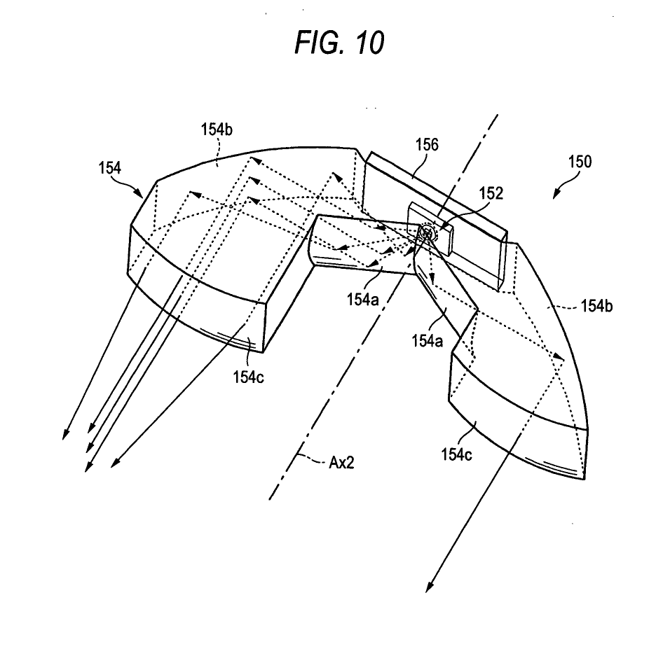

Next, the first modified example of the aforesaid embodiment will be explained. FIG. 10 is a perspective view showing a lamp unit 150 according to the first modified example. The lamp unit 150 is configured by a light emitting element 152, a translucent member 154 and a supporting plate 156, and used in a state of being disposed so as to be wide in the horizontal direction.

The configurations of the light emitting element 152 and the supporting plate 156 are substantially the same as the light emitting element 52 and the supporting plate 56 of the lamp unit 50. More specifically, although the translucent member 154 differs in the configuration of the irradiating surface 154c thereof from the configuration of the irradiating surface 54c of the translucent member 54 of the lamp unit 50, the configurations other than the irradiating surface of the translucent member 154 are substantially the same as those of the translucent member 54.

That is, the irradiating surface 154c of the translucent member 154 is formed as a wide rectangular shape in its outer configuration when seen from the front side thereof since the lamp unit 150 is disposed so as to be wide in the horizontal direction. In this state, the irradiating surface 154c is configured in its surface shape by a curved surface of a cylindrical surface shape having an arc shape in its horizontal section and extending in the vertical direction linearly.

Thus, the irradiation surface acts in a manner that the substantially parallel rays arriving at the irradiating surface 154c are maintained as substantially parallel rays with respect to the vertical direction. As to the horizontal direction, the substantially parallel rays arriving at the irradiation surface are once converged and emitted from the irradiating surface 154c as light spread in the horizontal direction. The translucent member 154 is formed in a manner that one of a pair of the left and right irradiating surfaces 154c is displaced in the forward direction with respect to the other irradiating surface 154c.

Also, in the case of employing the configuration of this modified example, the utilization factor of light from the light emitting element 152 can be enhanced and further the outer configuration of the lamp unit 150 seen from the front direction thereof can be set to a shape with a thin-width. Further, since the lamp unit 150 is disposed to be wide in the horizontal direction in this modified example, the lamp unit 150 can be designed as a unique one different from that of the lamp unit 50.

In this modified example, although a pair of the left and right irradiating surfaces 154c are disposed at different directions in the forward direction, since the light from the light emitting element 152 reflected by the inner surface of a first reflecting surface 154a is arranged to be reflected by the inner surface of a second reflecting surface 154b in the forward direction as substantially parallel rays, the irradiation light from each of a pair of the irradiating surfaces 154c can be controlled accurately.

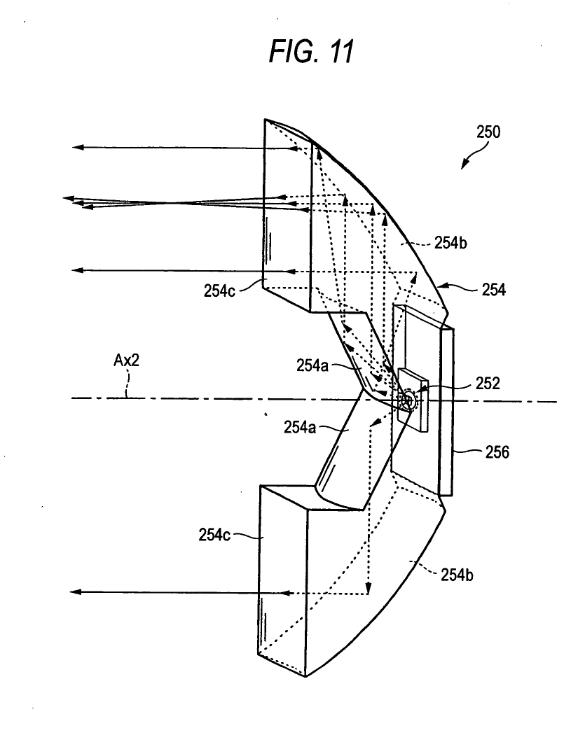

Next, the second modified example of the aforesaid embodiment will be explained. FIG. 11 is a perspective view showing a lamp unit 250 according to the second modified example. The lamp unit 250 is configured by a light emitting element 252, a translucent member 254 and a supporting plate 256. The configurations of the light emitting element 252 and the supporting plate 256 are same as the light emitting element 52 and the supporting plate 56 of the lamp unit 50.

Although the translucent member 254 differs in the configurations of the second reflecting surface 254b and the irradiating surface 254c thereof from the configurations of the second reflecting surface 54b and the irradiating surface 54c of the translucent member 54 of the lamp unit 50, the configurations other than the second reflecting surface and the irradiating surface of the translucent member 254 are substantially the same as those of the translucent member 54.

That is, the second reflecting surface 254b of the translucent member 254 is configured to reflect the light, irradiated from the light emitting element 252 and then reflected on the inner surface of the first reflecting surface 254a, in the forward direction by the inner surface of the second reflecting surface, and the second reflecting surface is configured to have a substantially parabolic shape in its vertical section. However, the second reflecting surface is not configured to be linear in its horizontal sectional shape but configured by a curved surface of an arc shape.

Thus, the first reflecting surface 254a acts such that the light from the light emitting element 252 is maintained as it is as substantially the parallel rays as to the vertical direction. As to the horizontal direction, the light from the light emitting element is reflected in the forward direction by the inner surface of the first reflecting surface. Further, the irradiating surface 254c of the translucent member 254 is configured by a vertical plane orthogonal to an optical axis Ax2. Thus, the irradiation surface acts in a manner that the light arrived at the irradiating surface 254c is maintained as it is as substantially the parallel rays as to the vertical direction, whilst, as to the horizontal direction, the light arrived at the irradiation surface is once converged and emitted from the irradiating surface 254c as light spread in the horizontal direction.

Also, in the case of employing the configuration of this modified example, the utilization factor of light from the light emitting element 252 can be enhanced and further the outer configuration of the lamp unit 250 seen from the front direction thereof can be set to a shape with a thin-width. Further, since the irradiating surface 254c of the translucent member 254 is configured by the plane in this modified example, the lamp unit 250 can be designed as a unique one different from that of the lamp unit 50.

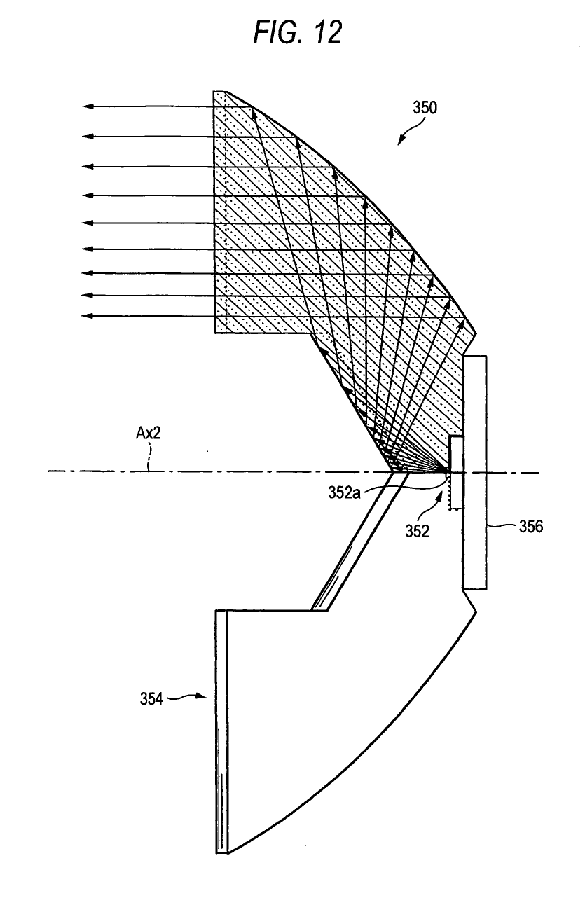

Next, the third modified example of the aforesaid embodiment will be explained. FIG. 12 shows a lamp unit 350 according to the third modified example and is similar to FIG. 5. The lamp unit 350 is configured by a light emitting element 352, a translucent member 354 and a supporting plate 356.

The configurations of the light emitting element 352, the translucent member 354 and the supporting plate 356 are substantially the same as the light emitting element 52, the translucent member 54 and the supporting plate 56 of the lamp unit 50. However, in this modified example, the light emitting chip 352a of the light emitting element 352 is directly sealed by the translucent member 354.

Also, in the case of employing the configuration of this modified example, the utilization factor of light from the light emitting element 352 can be enhanced and further the outer configuration of the lamp unit 350 seen from the front direction thereof can be set to a shape with a thin-width. Further, since the light emitting chip 352a is directly sealed by the translucent member 354, the translucent member 354 can also have a function of sealing resin. Thus, the configuration of the lamp unit 350 can be simplified and further loss of light flux due to the reflection at a boundary surface can be eliminated.

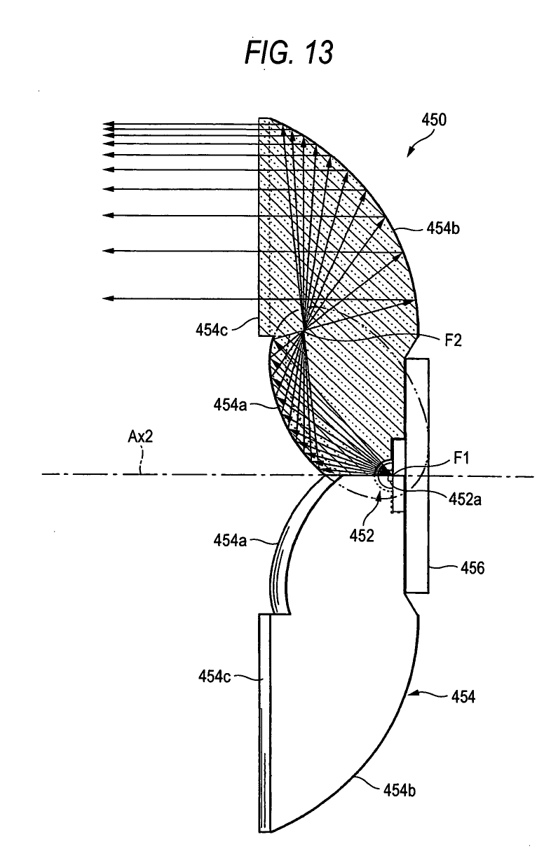

Next, the fourth modified example of the aforesaid embodiment will be explained. FIG. 13 shows a lamp unit 450 according to the fourth modified example and is similar to FIG. 5. The lamp unit 450 is configured by a light emitting element 452, a translucent member 454 and a plate 456.

The configurations of the light emitting element 452 and the plate 456 are same as the light emitting element 52 and the supporting plate 56 of the lamp unit 50.

Although the translucent member 454 differs in the configurations of the first and second reflecting surfaces 454a, 454b thereof from the configurations of the first and second reflecting surfaces 54a, 54b of the translucent member 54 of the lamp unit 50, the configurations other than the first and second reflecting surfaces of the translucent member 454 are same as those of the translucent member 54.

That is, in the translucent member 454, the first reflecting surface 454a is set to an elliptical shape in its vertical section in a manner that the center of the light emission of the light emitting chip 452a of the light emitting element 452 is set as a first focusing point F1 and a position between the first reflecting surface 454a and the second reflecting surface 454b is set as a second focusing point F2. Further, the second reflecting surface 454b is set to a parabolic shape in its vertical section in a manner that the second focusing point F2 is set as a focusing point. Incidentally, the first reflecting surface 454a of the translucent member 454 is set to a substantially parabolic shape in its horizontal section like the first reflecting surface 54a of the translucent member 54, and the second reflecting surface 454b is set to a linear shape in its vertical section like the second reflecting surface 54b of the translucent member 54.

Thus, the first reflecting surface 454a of the translucent member 454 reflects the light from the light emitting element 452 by the inner surface thereof in a manner that the light from the light emitting element is once converged and spread as to the direction along the vertical surface including the optical axis Ax, whilst the light from the light emitting element is not spread as to the direction along the horizontal plane. Further, the second reflecting surface 454b of the translucent member 454 reflects the light, irradiated from the light emitting element 452 and then reflected on the inner surface of the first reflecting surface 454a, in the forward direction as substantially parallel rays by the inner surface of the second reflecting surface.

Also, in the case of employing the configuration of this modified example, the utilization factor of light from the light emitting element 452 can be enhanced and further the outer configuration of the lamp unit 450 seen from the front direction thereof can be set to a shape with a thin-width. Further, since the first reflecting surface 454a of the translucent member 454 is set to the elliptical shape in its vertical section in this modified example, the size of the depth of the translucent member 454 can be set to a smaller value as compared with that of the translucent member 54 of the lamp unit 50.

Although in the lamp units 50, 60, 70 of the aforesaid embodiment, the explanation is made as to the case where the curvature of each of the irradiating surfaces 54c, 64c, 74c of the translucent members 54, 64, 74 is set to be the same value between a pair of the upper and lower irradiating surfaces, the curvature may be set to different values between a pair of the upper and lower irradiating surfaces. In this case, in a pair of the upper and lower irradiating surfaces of each of the irradiating surfaces 54c, 64c, 74c, since the spread angles of the lights irradiated therefrom in the horizontal direction differs to each other, unevenness of the light distribution can be hardly caused in the wide light distribution pattern formed by the light irradiated from each of the lamp units 50, 60, 70.

Each of the lamp units 150, 350 according to the first and third modified examples also has this feature.

Further, also in the lamp unit 250 according to the second modified example, when the curvature of the arc constituting the horizontal sectional shape of the second reflecting surface 254b of the translucent member 254 is set to be different between a pair of the upper and lower second reflecting surfaces 254b, unevenness of the light distribution can be hardly caused in the wide light distribution pattern formed by the light irradiated from the lamp unit 250.

In the above-mentioned exemplary, non-limiting embodiments of the present invention, the lamp unit for a vehicle is disclosed as a lamp unit for the illumination lamp (such as head lamp, fog lamp, cornering lamp, backup lamp, or the like). However, the lamp unit is not limited thereto. For example, but not by way of limitation, the lamp unit for a vehicle of the present invention can be used as a lamp unit for an indicating lamp (such as rear combination lamp, turn signal lamp, tail lamp, stop lamp, or the like) for lighting the lamp so that another driver or street walker can recognize the driver's intention or the presence of vehicle. As a result, the action and technical effects similar to those of the aforesaid embodiments can be obtained, so long as a configuration similar is employed. In this case, the same aiming mechanism may not be required.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

1. A lamp unit for a vehicle, comprising:
a light emitting element disposed toward a forward direction on an optical axis extending in a front-to-rear direction of the lamp unit; and
a translucent member that covers the light emitting element from a forward side thereof, said translucent member comprising,
a first reflecting surface having an inner surface portion that reflects light incident from the light emitting element and radially outward from the optical axis, such that the reflected light is spread along a plane including the optical axis, but not orthogonal to the plane,
a second reflecting surface having an inner surface portion that reflects the light reflected by the first reflecting surface, in the forward direction, and
an irradiating surface that emits the light reflected by the second reflecting surface in the forward direction from the translucent member.

2. A lamp unit for a vehicle according to claim 1, wherein the light emitting element includes a light emitting chip and a sealing resin that seals the light emitting chip.

3. A lamp unit for a vehicle according to claim 1, wherein the second reflecting surface is a substantially cylindrical curved surface that reflects on its inner surface the light reflected by the first reflecting surface in the forward direction as substantially parallel rays.

4. A lamp unit for a vehicle according to claim 1, wherein the first reflecting surface, the second reflecting surface and the irradiating surface are formed on both sides of the optical axis.

5. An illumination lamp for a vehicle which is configured by providing a plurality of the lamp units for a vehicle according to claim 1 in a direction orthogonal to the plane.

6. A lamp for a vehicle, comprising:
a plurality of lamp units within a lamp chamber of a lamp body, said lamp units including,
a first type of said lamp units that is of a projection type, and
a second type of said lamp units having a light emitting element, a translucent member and a supporting plate, wherein said translucent member includes a first reflecting surface that reflects light from said light emitting element and to a second reflecting surface, and an irradiating surface that receives light reflected by said second surface and emits light in a forward direction of the lamp unit.

7. The lamp of claim 6, wherein said first reflecting surface is a substantially parabolic cylindrical surface, having a substantially parabolic shape in its horizontal direction and extending in an inclined vertical direction linearly.

8. The lamp of claim 6, wherein said second reflecting surface has a substantially parabolic shape in its vertical direction and extends linearly in a horizontal direction orthogonal to an optical axis of said second type of lamp.

9. The lamp of claim 6, wherein the irradiating surface has a curved cylindrical surface that is an arc shape horizontally and extends in linearly in a vertical direction, so as to horizontally spread incoming parallel rays of light.

10. The lamp of claim 9, wherein a curvature of said arc shape of the irradiating surface can be varied between ones of said plurality of lamp units of said second type so as to correspondingly vary a horizontal sectional shape of said irradiating surface.

11. The lamp of claim 10, wherein said plurality of lamp units of said second type are substantially rectangular in a lengthwise direction, and are varied such set a first set of said second type of said lamp units are vertically aligned at a first position of said lamp, a second set of said second type of said lamp units are vertically aligned at a second position of said lamp, and a third set of said second type of said lamp units are vertically aligned at a third position of said lamp, and further wherein said first type of lamp is positioned between each of said first, second and third sets of lamps.

12. The lamp of claim 6, wherein said second type of said plurality of lamp units is positioned one of vertically and horizontally.

13. The lamp of claim 12, wherein when said second type of said plurality of lamp units is positioned horizontally, the irradiating surface has a curved cylindrical surface that is an arc shape horizontally and extends in linearly in a vertical direction, so as to horizontally spread incoming parallel rays of light.

14. The lamp of claim 6, wherein said second reflecting surface is substantially planar.

15. The lamp of claim 6, wherein said light emitting element comprises a light emitting chip directly sealed by said translucent member.

16. The lamp of claim 6, wherein said first reflecting surface is elliptical in its vertical section having as its focal point said light emitting element, and said second reflecting surface is substantially parabolic in its vertical section having as its focal point a position between said first reflecting surface and said second reflecting surface.

17. The lamp of claim 16, wherein said first reflecting surface is substantially parabolic in a horizontal direction and said second reflecting surface is substantially linear in its vertical direction.

18. The lamp of claim 9, wherein an upper portion and a lower portion of said reflecting surface of said second type of lamp units can have curvatures that are different from each other.

19. A head lamp for a vehicle, comprising:
a plurality of lamp units within a lamp chamber of a lamp body, said lamp units including,
a first type of said lamp units that is of a projection type, and
a second type of said lamp units having a light emitting element, a translucent member and a supporting plate, wherein said translucent member includes a first reflecting surface that reflects light from said light emitting element and to a second reflecting surface, and an irradiating surface that receives light reflected by said second surface and emits light in a forward direction of the lamp unit.
